(19) United States
(12) Patent Application Publication
(10) Pub. No.: US 2021/0192231 A1
(43) Pub. Date: Jun. 24, 2021

(54) ADAPTIVE MULTIPLE REGION OF INTEREST CAMERA PERCEPTION

(71) Applicant: QUALCOMM Incorporated, San Diego, CA (US)

(72) Inventors: Hee-Seok LEE, Yongin-si (KR); Heesoo MYEONG, Seoul (KR); Hankyu CHO, Seoul (KR)

(21) Appl. No.: 16/723,925

(22) Filed: Dec. 20, 2019

(51) Int. Cl. G06K 9/00; G06T 7/11; G06T 7/136; G06T 3/40; G05D 1/02

(52) U.S. Cl. CPC G06K 9/00798; G06T 7/11; G06T 7/136; G06T 3/4053; G06T 2207/20084; G05D 1/0231; G06K 9/00651; G06T 2207/30261; G05D 2201/0213; G06K 9/00805

(57) ABSTRACT

Autonomous driving systems described herein provide an efficient way to manage camera-based perception by considering the characteristics of captured images. In one example, a camera sensor may capture an image and a processor may determine a first region of interest (ROI) within the image and a second ROI within the image. The processor may generate a first image of the first ROI and a second image of the second ROI. The processor may transmit a control signal based on one or more objects detected in the first ROI and/or one or more objects detected in the second ROI to cause the vehicle to perform an autonomous driving operation.

### FIELD OF DISCLOSURE

This disclosure relates generally to camera perception, and more specifically, but not exclusively, to camera perception for multiple regions of interest.

### BACKGROUND

In recent years, technology companies have begun developing and implementing technologies that assist drivers in avoiding accidents and enabling an automobile to drive itself. So called “self-driving cars” include sophisticated sensor and processing systems that control the vehicle based on information collected from the vehicle's sensors, processors, and other electronics, in combination with information (e.g., maps, traffic reports, etc.) received from external networks (e.g., the “Cloud”). As self-driving and driver-assisting technologies grow in popularity and use, so will the importance of protecting motor vehicles from malfunction. Due to these emerging trends, new and improved solutions that better identify, prevent, and respond to misinformation on modern vehicles, such as autonomous vehicles and self-driving vehicles, will be beneficial to consumers.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In an aspect, an apparatus includes a camera sensor of a vehicle, and at least one processor communicatively coupled to the camera sensor, the at least one processor configured to receive an image from the camera sensor, determine a first region of interest (ROI) within the image, generate a first image of the first ROI, determine a second ROI within the image based on an expected future position of the vehicle, and generate a second image of the second ROI.

In an aspect, a method includes receiving an image from a camera sensor of a vehicle, determining a first ROI within the image, generating a first image of the first ROI, determining a second ROI within the image based on an expected future position of the vehicle, and generating a second image of the second ROI.

In an aspect, an apparatus includes means for receiving an image from a camera sensor of a vehicle, means for determining a first ROI within the image, means for generating a first image of the first ROI, means for determining a second ROI within the image based on an expected future position of the vehicle, and means for generating a second image of the second ROI.

In an aspect, a non-transitory computer-readable medium storing computer-executable instructions includes computer-executable instructions comprising at least one instruction instructing a processor to receive an image from a camera sensor of a vehicle, at least one instruction instructing the processor to determine a first ROI within the image, at least one instruction instructing the processor to generate a first image of the first ROI, at least one instruction instructing the processor to determine a second ROI within the image based on an expected future position of the vehicle, and at least one instruction instructing the processor to generate a second image of the second ROI.

Other features and advantages associated with the apparatus and methods disclosed herein will be apparent to those skilled in the art based on the accompanying drawings and detailed description.

### BRIEF DESCRIPTION OF THE DRAWINGS

FIG. 1 illustrates an adaptive ROI on a straight lane in accordance with some examples of the disclosure.

FIG. 2 illustrates an adaptive ROI on a curved lane in accordance with some examples of the disclosure.

FIG. 3 illustrates lane information in accordance with some examples of the disclosure.

FIG. 4 illustrates using velocity and centripetal acceleration information in accordance with some examples of the disclosure.

FIG. 5 illustrates using steering and speed information in accordance with some examples of the disclosure.

FIG. 6 illustrates a method for operating a vehicle in accordance with some examples of the disclosure.

FIG. 7 illustrates various electronic devices that may be integrated with any of the aforementioned apparatus or methods in accordance with some examples of the disclosure.

FIG. 8 illustrates an example camera sensor apparatus in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

In images captured by a camera sensor of an autonomous or semi-autonomous vehicle (referred to as an “ego” or “host” vehicle), objects (e.g., other vehicles, pedestrians, traffic signs, traffic lights, lane boundaries, etc.) in the images that are farther from the ego vehicle generally appear near the center of the image, while objects that are closer to the ego vehicle generally appear on the sides of the image. Based on these observations, the present disclosure provides techniques for adaptive multiple region of interest (ROI) camera perception for autonomous driving. In an aspect, an ego vehicle (specifically its on-board computer (OBC)) may identify different ROIs in a camera image and generate new images corresponding to the identified ROIs. For instance, to identify nearby objects, which are generally larger in size in a camera image, the ego vehicle may identify an ROI that corresponds to the entire image, but may downscale the image to reduce its size. To identify farther objects, which are generally smaller in size in a camera image, the ego vehicle may identify one or more ROIs that are cropped versions of the original camera image, and may also upscale these image segments to more easily recognize the smaller/farther objects. Although this approach generates multiple images, it can reduce the total computational cost by reducing the sizes and/or resolutions of the images of the ROIs. It can also provide the same or higher object detection accuracy as processing only the original image, as upscaling ROIs containing smaller/farther objects can enable the ego vehicle to better “see” (detect, identify) these objects).

The various techniques disclosed herein may be implemented by a computing system of the ego vehicle. The computing system may be, or may be implemented in, a mobile computing device within the ego vehicle, the ego vehicle's control system(s) or on-board computer, or a combination thereof. The monitored sensors may include any combination of closely-integrated vehicle sensors (e.g., camera sensor(s), radar sensor(s), light detection and ranging (LIDAR) sensor(s), etc.). The term “sensor” may include a sensor interface (such as a serializer or deserializer), a camera sensor, a radar sensor, a LIDAR sensor, or similar sensor.

Sensors, such as cameras, may be located around a vehicle to observe the vehicle's environment. Images captured by these cameras may be fed to the vehicle's control system for processing to identify objects around the vehicle. Vehicle control based on captured images may use a feedback loop in which the control system updates the camera configuration and region of interest for future images based on analysis of the current image (also referred to as a “frame”).

The term “system on chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., read-only memory (ROM), random access memory (RAM), flash memory, etc.), and resources (e.g., timers, voltage regulators, oscillators, etc.). SoCs may also include software for controlling the integrated resources and processors, as well as for controlling peripheral devices.

Over the past several years, the modern automobile has been transformed from a self-propelled mechanical vehicle into a powerful and complex electro-mechanical system that includes a large number of sensors, processors, and SoCs that control many of the vehicle's functions, features, and operations. Modern vehicles are now often also equipped with a vehicle control system, which may be configured to collect and use information from the vehicle's various systems and sensors to automate all (full autonomy) or a portion (semi-autonomy) of the vehicle's operations.

For example, manufacturers now often equip their automobiles with an advanced driver assistance system (ADAS) that automates, adapts, or enhances the vehicle's operations. The ADAS may use information collected from the automobile's sensors (e.g., accelerometer, radar, LIDAR, geospatial positioning, etc.) to automatically recognize (i.e., detect) a potential road hazard, and assume control over all or a portion of the vehicle's operations (e.g., braking, steering, etc.) to avoid the detected hazards. Features and functions commonly associated with an ADAS include adaptive cruise control, automated lane detection, lane departure warning, automated steering, automated braking, and automated accident avoidance.

In conventional autonomous and semi-autonomous vehicle systems, camera-based perception is a key component of autonomous and semi-autonomous driving. Such perception using image data from camera sensors requires significant computational resources, especially when the resolution of the images is high. However, it is beneficial to use high-resolution images because the additional detail enables the ego vehicle to “see” farther objects. Thus, conventional systems sacrifice the computational cost of processing high-resolution images to obtain the accuracy provided by high-resolution images. Accordingly, it would be beneficial to lower the processing costs associated with processing high-resolution images, while maintaining the accuracy provided by such images.

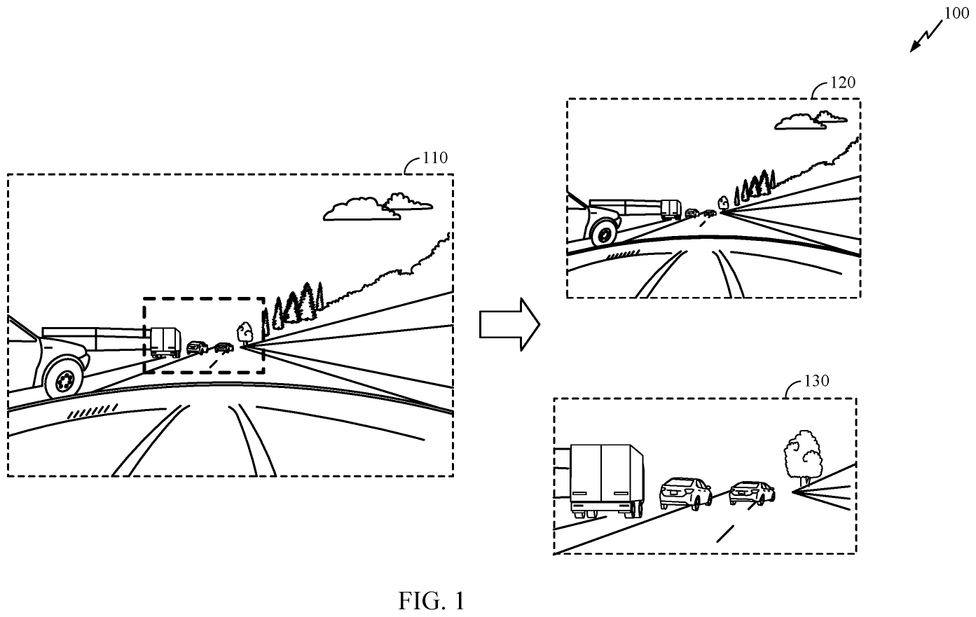

FIG. 1 is a diagram 100 illustrating an adaptive ROI on a straight lane in accordance with some examples of the disclosure. As shown in FIG. 1, an original image 110 captured by a camera sensor (not shown) may be processed to generate a first image 120 corresponding to a first ROI in the original image 110 and a second image 130 corresponding to a second ROI in the original image 110. As described further below, the first image 120 may correspond to the original image 110 but have a lower resolution, and the second image 130 may correspond to only a portion of the original image 110 and have the same or higher resolution.

The original image 110 may be a high resolution image and, although only two ROIs are shown, it should be understood that more than two ROIs may be determined (and further processed similarly). In addition, although the original image 110, first image 120, and second image 130 are shown as rectangular, it should be understood that these images may be other shapes such as square, polygon, circle, etc. and each of the respective shapes of the first image 120, second image 130, and/or any additions images may be different from one another.

There are various ways to determine ROIs of an original image 110, such as the first ROI and the second ROI in FIG. 1. Since there may be redundant areas in the original image 110, such as the hood of the vehicle and/or the sky. In addition, nearby objects generally appear near the edges of the original image 110 (e.g., the front of a target vehicle beside the ego vehicle is visible at the edge of the original image 110) and farther target objects generally appear near the center of the original image 110, which generally corresponds to the vanishing point of the lane (e.g., the point or portion of an image where two boundaries of a lane or multiple lanes appear to converge, or a point or portion where the lane disappears (e.g., around a corner, over a hill, etc.)). The vanishing point of the lane may also be an expected future position of the vehicle, insofar as the vehicle is expected to follow the roadway to that point over some period of time. Thus, it may be beneficial to treat different regions of the original image 110 differently. For example, it may be beneficial to have one or more ROIs for detecting nearby objects and one or more ROIs for detecting farther objects.

One of the ROIs in an original image (e.g., original image 110) may correspond to the vanishing point of the lane in which the ego vehicle is travelling (referred to as the “ego lane”), thereby providing a view of target objects (e.g., vehicles) further down the road from the ego vehicle. As will be appreciated, the lane may be straight, curve left or right, or rise or fall in elevation. As such, the vanishing point of the ego lane will not always be in the center of an original image. Rather, it may be higher than the center (e.g., if the ego lane is rising), lower than the center (e.g., if the ego lane is dropping/descending in elevation), to the left of center (e.g., if the lane is curving left), or to the right of center (e.g., if the lane is curving right). The location of the vanishing point may also depend on how the camera is aimed, insofar as the camera may not be aimed such that the center point of any captured images will correspond to the vanishing point of the lane when the lane is level/straight.

The vanishing point of the lane may be determined based on a number of factors, such as the steering direction, speed of the vehicle, and/or lane information. The steering direction and speed of the vehicle may be determined from hardware or software signals received from a global navigation satellite system (GNSS), vehicle steering controls, speedometer, one or more previously processed images, etc. The lane information may be retrieved from a previously stored road map, detected lane markers, detected vehicles from current or past images, etc. A road map can provide lane geometry such as whether the lane is going uphill or downhill, curving left or right, straight, etc. Lane detections can show whether the vanishing point of a lane is near the center/left/right/top/bottom of the image frame, which can indicate which direction the lane is going (straight, curving left, curving right, up, down). Detections of small (e.g., less than some threshold size) vehicles at the center/left/right/top/bottom of the current or previous images can also indicate which direction the lane is going (straight, curving left, curving right, up, down). The speed of the vehicle may indicate whether the vehicle is traveling in a straight line or around a curve. For example, if the speed limit on the road is known (e.g., from the map) and the vehicle is traveling slower than that speed (e.g., as determined by GNSS or speedometer), it may indicate that the vehicle is going around a curve or up a hill. Alternatively, if the vehicle is traveling at or above the speed limit, it may indicate that the vehicle is traveling in a straight lane or a down a hill.

With reference to FIG. 1, the illustrated images were captured by a vehicle moving forward on a straight road. As mentioned above, the first image 120 corresponds to the entire original image 110, and the second image 130 corresponds to a portion of the original image 110 near where the vanishing point of the lane is expected to be (here, near the center of the original image 110). The determination of the lane as straight and the identification of the vanishing point of the lane may be performed using the information and techniques in the preceding paragraph.

Once the first image 120 and the second image 130 (and any additional images corresponding to any additional ROIs) are determined, the images may be subject to upscaling and/or downscaling. In the example of FIG. 1, the first image 120 may be downscaled and the second image 130 may be upscaled. The first image 120 may be downscaled since it will be used to detect objects closer to the ego vehicle, which appear larger (e.g., greater than some threshold size) in the first image 120, and are therefore easier to detect in a lower resolution image. The second image 130 may or may not be upscaled, depending on the resolution of the original image 110, and depending on the amount of image detail needed to accurately detect the objects in the second image 130.

It should be understood that in some examples herein, recognizing or detecting a road environment includes detecting objects and/or lanes, recognizing road conditions, and changing traffic conditions, etc. In some examples, the first image 120 may be larger than the second image 130, but the first image 120 may not always be downscaled, and the second image 130 may not always be upscaled. For example, there may be a preferred resolution to be used to complete the camera perception tasks (e.g., detecting the road environment, objects, etc.) with a certain amount of latency, and ROI images may be resized to the preferred resolution. If the first image 120 is smaller than the preferred resolution, then the first image 120 may be upscaled. On the other hand, if the second image 130 is larger than the preferred resolution, then the second image 130 may be downscaled.

The (downscaled) first image 120 and the (upscaled) second image 130 may be processed to recognize (i.e., detect) a road environment including objects (e.g., other vehicles, debris, construction barriers, humans, animals, etc.) or other items of interest (e.g., traffic signs, railway crossings, stopped school buses, etc.). Thereafter, one or more autonomous control signals may be provided to operate the vehicle based on the detections. These transmissions may be wireless or wired. In addition, the processing and determining described above may be performed in parallel by a single processor or core, or may be processed in parallel by separate dedicated processors or cores, and/or may be processed by one or more processors or cores configured as a neural network.

The described techniques may optimize the tradeoff between the speed of processing images from the camera and the accuracy of the object detections for autonomous driving. For instance, a higher input resolution may permit a longer detection range (i.e., detection of farther away target objects) while a lower input resolution may result in faster image processing and object detection. Using multiple ROIs with different scaling, such as the first image 120 and the second image 130, instead of processing the entire high resolution original image 110, may achieve better results in terms of the speed of processing images while maintaining similar or improved accuracy for object detection.

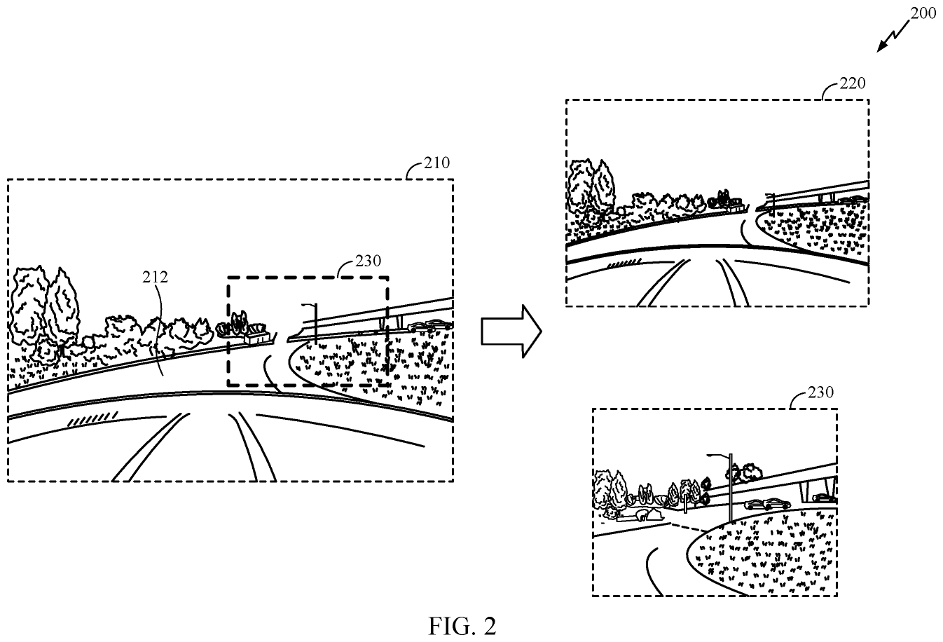

FIG. 2 is a diagram 200 illustrating an adaptive ROI on a curved lane in accordance with some examples of the disclosure. In FIG. 2, an original image 210 captured by a camera sensor (not shown) may be used by a processor or similar computing element (not shown) to determine a first image 220 corresponding to a first ROI in the original image 210 and a second image 230 corresponding to a second ROI in the original image 210. Note that although only two ROIs are shown, it should be understood that more or fewer than two ROIs may be determined (and further processed similarly). In addition, although the image 210, first image 220, and second image 230 are shown as rectangular, it should be understood that the image and ROIs may be other shapes, such as square, polygon, circle, etc., and each of the respective shapes may be different.

As may be seen in FIG. 2, the lane 212 curves to the right. However, as will be appreciated, this is merely an example, and the lane 212 may curve to the left and/or rise or fall in elevation. As described above, the direction the lane 212 is curving may be determined based on right steering, the vanishing point of the lane 212 being to the right of image center, small (i.e., far) vehicles detected to the right of image center, and the like. Thus, in the example of FIG. 2, the second ROI should be located on the right side of image 210.

Once the first image 220 and the second image 230 (and/or any additional images corresponding to additional ROIs) are determined, the ROIs may be subject to upscaling and/or downscaling. In this example, the first image 220 may be downscaled and the second image 230 may be upscaled. The downscaled first image 220 and the upscaled second image 230 may be processed to detect obstacles (e.g., other vehicles, humans, animals, debris, construction barriers, etc.) or other items of interest (e.g., traffic signs, railway crossings, stopped school buses, etc.). Thereafter, one or more autonomous control signals may be generated to operate the vehicle based on the object detections. Such operations may include steering, braking, accelerating, etc.

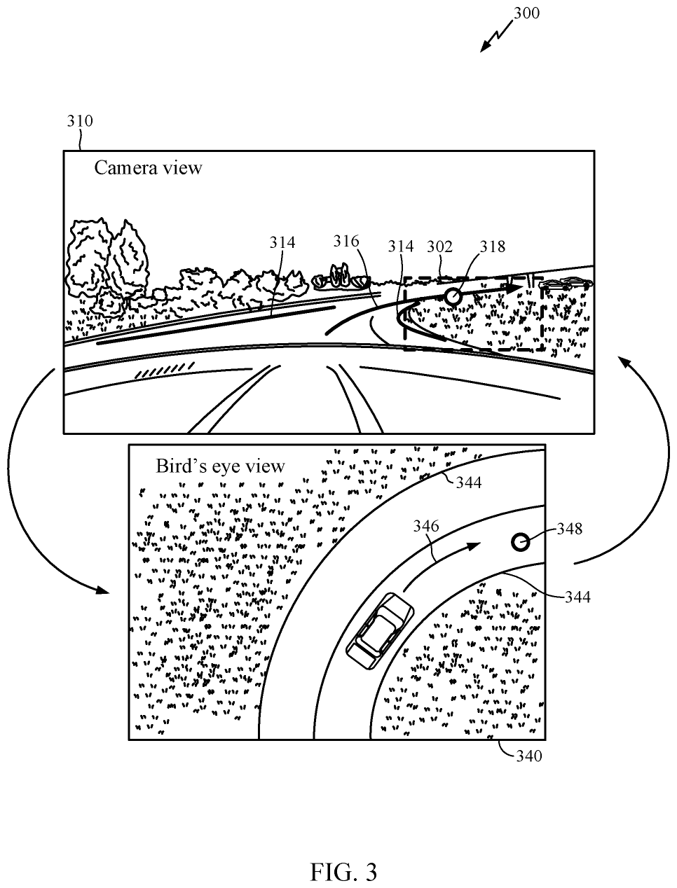

FIG. 3 illustrates lane information in accordance with some examples of the disclosure. FIG. 3 illustrates an example 300 of setting an adaptive ROI using lane information. As discussed above, the lane information may be estimated from current or previous images, or given by an HD map (e.g., a lane level map) previously acquired, downloaded as needed, or previously stored in a memory. In example 300, an image 310 is captured by a camera (not shown) and a bird's eye view 340 of the image 310 is generated by a processor (not shown). The image 310 may be processed to detect lane boundaries 314 using any known technique (e.g., lane boundary detection using a random sample consensus (RANSAC) method or segmentation using a deep neural network (DNN)). The lane boundary detections are then projected onto the bird's eye view 340 as lane boundaries 344. The lane boundaries 344 may then be extrapolated to a point further down the roadway (e.g., the vanishing point of the lane boundaries 314 in the image 310) using a second or higher-order polynomial, for example. An expected path 316 and 346 of the roadway may be determined in the image 310 and the bird's eye view 340, respectively, using the extrapolated lane boundaries 314 and 344, respectively. An expected vehicle position 348 after t seconds (e.g., two seconds) may be determined in the bird's eye view 340. The expected vehicle position 348 may depend on vehicle speed, steering wheel position, blinker status (which may indicate whether the vehicle is changing lanes, turning, taking an exit, etc.), etc. The expected vehicle position 348 may be projected back to the image 310 as expected vehicle position 318. An ROI 302 may be determined as a rectangle (or other shape) centered at the expected vehicle position 318.

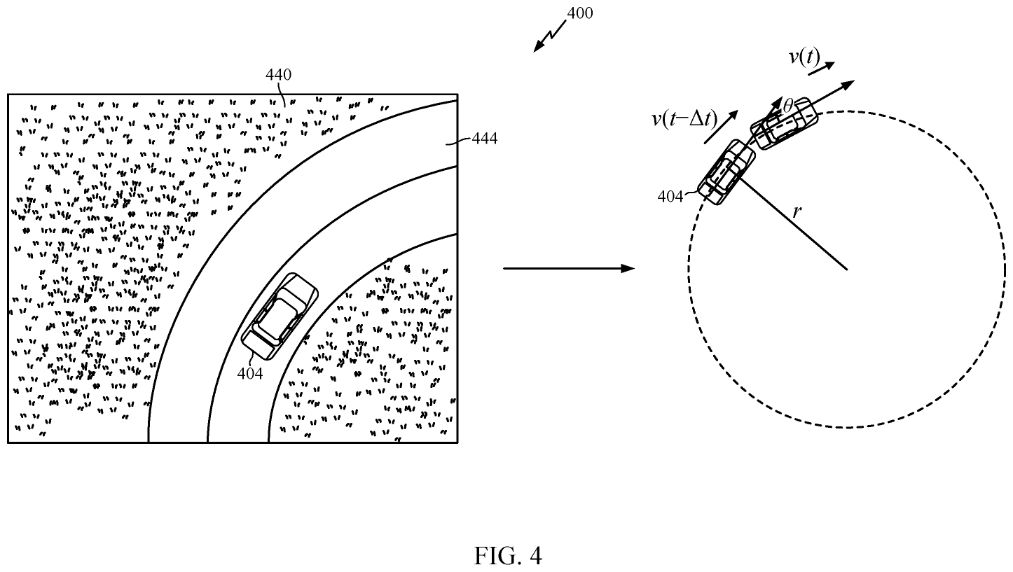

FIG. 4 illustrates an example 400 of using velocity and centripetal acceleration information in accordance with some examples of the disclosure. More specifically, FIG. 4 illustrates an example 400 that uses steering and speedometer information to determine ROIs. As can be seen, example 400 depicts a bird's eye view 440 that shows a curved lane 444. Curved motions maybe interpreted as circular motions for a short period of time. Thus, the radius (r) of the circle may be determined using the current velocity (v) and centripetal acceleration (a) from the speedometer of the vehicle 404 as r=v²/α from α=v²/r.

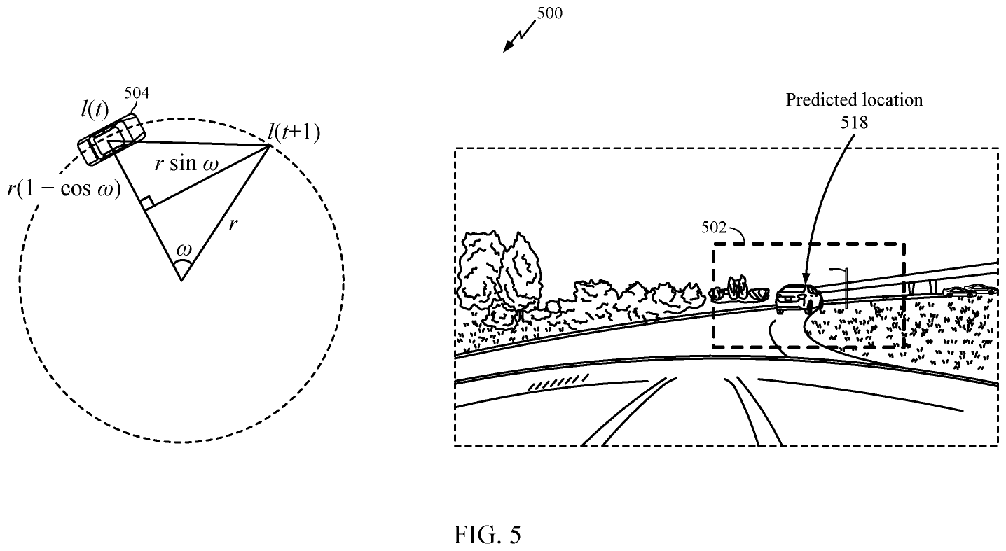

FIG. 5 illustrates an example 500 of using velocity and centripetal acceleration information in accordance with some examples of the disclosure. As shown in FIG. 5, the radius (r=v²/α) and the angular velocity ω=v/r can be used to predict the location of the vehicle 504 (currently located at location l(t)) at the next time step, t+1. That is, the radius (r) and angular velocity (w) can be used to predict location l(t+1). In example 500, the ROI 502 may be determined to be centered on the predicted location 518 of the vehicle 504 at t+1 (i.e., location l(t+1)). As shown on the left side of FIG. 5, the distance should be r sin ω in the current direction and r(1−cos ω) in the perpendicular direction relative to the current direction of the vehicle.

The techniques described above may achieve efficiency over conventional approaches by reducing the complexity of processing (e.g., detecting objects in) images from camera sensors. This efficiency may be enhanced by using neural network configured processors applied for perception with the complexity being proportional to the number of pixels. Using the present techniques, the number of pixels to be processed may be smaller than conventional approaches (e.g., due to only needing to process ROIs instead of an entire image), with similar or improved accuracy. In addition, efficiency may be enhanced by parallel processing the ROIs as described above.

In some aspects, multiple DNNs can be run for the different ROIs. The multiple DNNs may be implemented by the one or more processors disclosed herein. More specifically, SoCs for autonomous driving or ADAS generally have multiple processor cores for parallel DNN processing. For example, one DNN can be used to process the first ROI (e.g., the entire image) with downscaling to recognize large/close objects. One or more other DNNs can be used to process one or more additional ROIs (e.g., the second ROI, which is cropped with upscaling) to recognize small/distant objects. It will be appreciated that in some aspects, these multiple images derived from the various ROIs can be processed in parallel to improve system performance (e.g., speed of image processing, recognition of small/distant objects, etc.). Although multiple DNNs may be used to process the various images of the ROIs, the total computational cost can remain the same or be lower than conventional systems, while keeping the same or higher accuracy (e.g., by upscaling ROIs containing small/distant objects the ability to detect the small/distant objects is enhanced due to the larger number of pixels representing the objects as compared to the original image). Conventional systems have slow image processing speeds when processing the high-resolution images used for conventional autonomous driving vehicles. However, high-resolution images are used to be able to resolve smaller objects or objects farther away, which aids in safe driving. The various aspects disclosed herein allow for improved processing speed, while maintaining the ability to resolve smaller objects, as discussed herein.

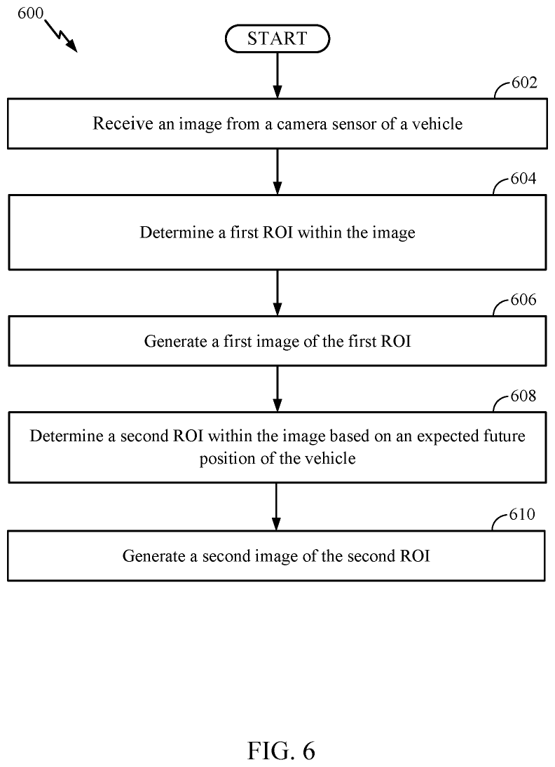

FIG. 6 illustrates a method 600 for operating a vehicle in accordance with some examples of the disclosure. In an aspect, method 600 may be performed by the on-board computer (comprising one or more processors) of an autonomous or semi-autonomous vehicle. As shown in FIG. 6, method 600 begins at block 602 with receiving an image from a camera sensor of a vehicle. Method 600 continues at block 604 with determining a first ROI in the image. Method 600 continues at 606 with generating a first image of the first ROI. Method 600 continues at 608 with determining a second ROI in the image based on an expected future position of the vehicle. Method 600 continues at block 610 with generating a second image of the second ROI.

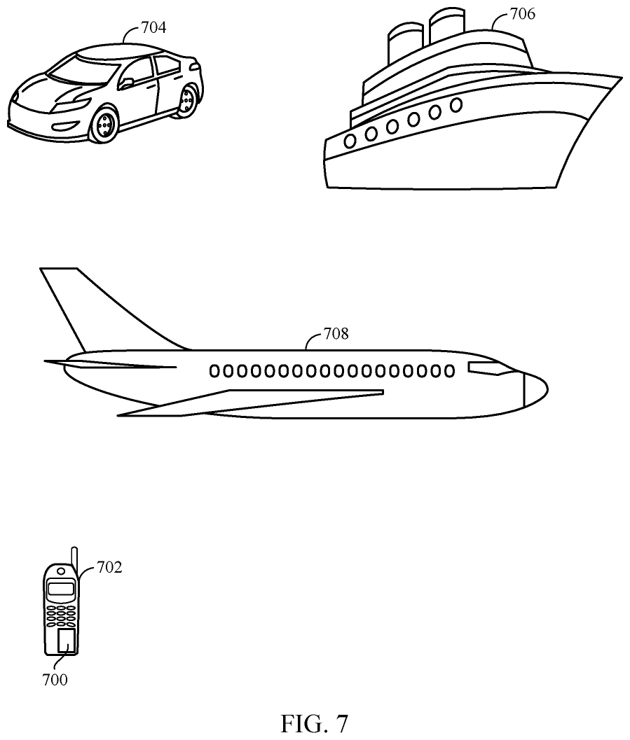

FIG. 7 illustrates various electronic devices that may be integrated with any of the aforementioned apparatus and methods in accordance with some examples of the disclosure. For example, a mobile phone device 702, an automotive vehicle 704, a mobile vehicle such as a watercraft 706 or an aircraft 708 may include an integrated device 700 as described herein (e.g., a camera sensor apparatus). The integrated device 700 may be, for example, any of the processors, integrated circuits, SoCs, registers, logic circuits described herein. The devices 702, 704, 706, and 708 illustrated in FIG. 7 are merely exemplary. Other electronic devices may also feature the integrated device 700 including, but not limited to, a group of devices (e.g., electronic devices) that includes mobile devices, hand-held personal communication systems (PCS) units, portable data units such as personal digital assistants, global positioning system (GPS) enabled devices, navigation devices, set top boxes, music players, video players, entertainment units, fixed location data units such as meter reading equipment, communications devices, smartphones, tablet computers, computers, wearable devices, servers, routers, electronic devices implemented in automotive vehicles (e.g., autonomous vehicles), or any other device that stores or retrieves data or computer instructions, or any combination thereof.

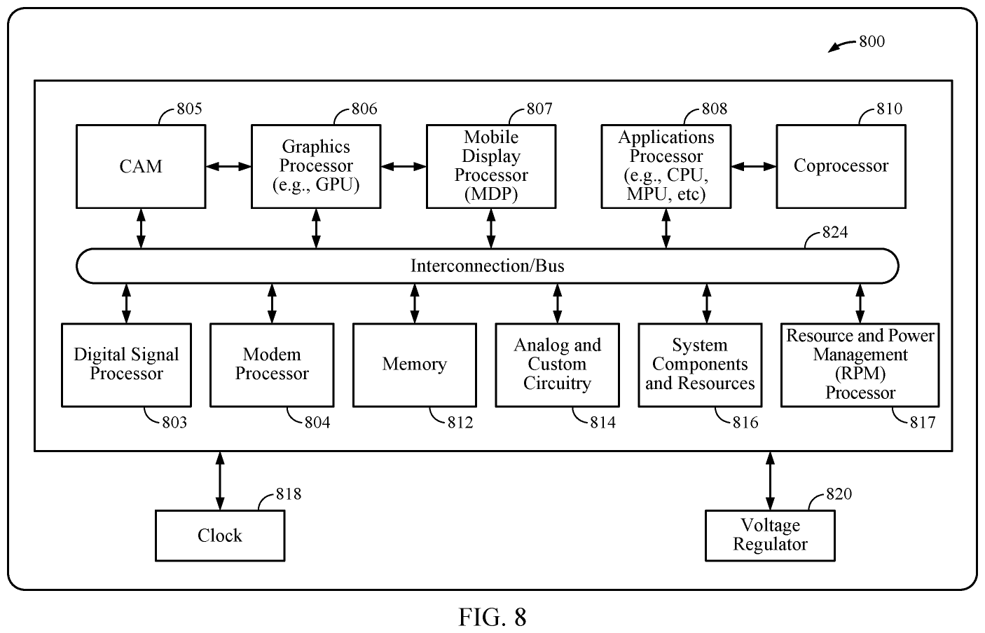

FIG. 8 illustrates an example apparatus 800 architecture that may be used in implementing the various examples herein. The apparatus 800 may include a number of heterogeneous processors, such as a digital signal processor (DSP) 803, a modem processor 804, a graphics processor 806, a mobile display processor (MDP) 807, an applications processor 808, and a resource and power management (RPM) processor 817. The apparatus 800 may also include one or more coprocessors 810 (e.g., vector co-processor) connected to one or more of the heterogeneous processors 803, 804, 806, 807, 808, 817. Each of the processors 803, 804, 806, 807, 808, 817 may include one or more cores, and an independent/internal clock. Each processor/core may perform operations independent of the other processors/cores. For example, the apparatus 800 may include a processor that executes a first type of operating system (e.g., FreeBSD, LINUX, OS X, etc.) and a processor that executes a second type of operating system (e.g., Microsoft Windows). In some embodiments, the applications processor 808 may be the apparatus' 800 main processor, central processing unit (CPU), microprocessor unit (MPU), arithmetic logic unit (ALU), etc. The graphics processor 806 may be the graphics processing unit (GPU).

The apparatus 800 may include analog circuitry and custom circuitry 814 for managing sensor data, analog-to-digital conversions, wireless data transmissions, and for performing other specialized operations, such as processing encoded audio and video signals for rendering in a web browser. The apparatus 800 may further include system components and resources 816, such as voltage regulators, oscillators, phase-locked loops, peripheral bridges, data controllers, memory controllers, system controllers, access ports, timers, and other similar components used to support the processors and software clients (e.g., a web browser) running on a computing device. The apparatus 800 also includes specialized circuitry (CAM) 805 that includes, provides, controls and/or manages the operations of one or more cameras (e.g., a primary camera, webcam, 8D camera, etc.), the video display data from camera firmware, image processing, video preprocessing, video front-end (VFE), in-line JPEG, high definition video codec, etc. The CAM 805 may be an independent processing unit and/or include an independent or internal clock.

The system components and resources 816, analog and custom circuitry 814, and/or CAM 805 may include circuitry to interface with peripheral devices, such as cameras, electronic displays, wireless communication devices, external memory chips, etc. The processors 803, 804, 806, 807, 808 may be interconnected to one or more memory elements 812, system components and resources 816, analog and custom circuitry 814, CAM 805, and RPM processor 817 via an interconnection/bus module 824, which may include an array of reconfigurable logic gates and/or implement a bus architecture (e.g., CoreConnect, AMBA, etc.). Communications may be provided by advanced interconnects, such as high performance networks-on-chip (NoCs).

The apparatus 800 may further include an input/output module (not illustrated) for communicating with resources external to the apparatus 800, such as a clock 818 and a voltage regulator 820. Resources external to the apparatus 800 (e.g., clock 818, voltage regulator 820) may be shared by two or more of the internal SoC processors/cores (e.g., a DSP 803, a modem processor 804, a graphics processor 806, an applications processor 808, etc.).

In some examples, the apparatus 800 may be included in a computing device, which may be included in an automobile. The computing device may include communication links for communication with a telephone network, the Internet, and/or a network server. Communication between the computing device and the network server may be achieved through the telephone network, the Internet, private network, or any combination thereof. The apparatus 800 may also include additional hardware and/or software components that are suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, etc.), cameras, compasses, GPS receivers, communications circuitry (e.g., Bluetooth®, WLAN, WiFi, etc.), and other well-known components (e.g., accelerometer, etc.) of modern electronic devices.

It will be appreciated that various aspects disclosed herein can be described as functional equivalents to the structures, materials and/or devices described and/or recognized by those skilled in the art. It should furthermore be noted that methods, systems, and apparatus disclosed in the description or in the claims can be implemented by a device comprising means for performing the respective actions of this method. For example, in one aspect, an apparatus may comprise means for capturing an image (e.g., sensor or camera); and means for processing an image (e.g., processor or similar computing element) communicatively coupled to the means for capturing an image, the means for processing an image configured to: receive the image from the means for capturing an image; determine a first ROI within the image; determine a second ROI within the image based on an expected future position of the vehicle; and generate a control signal based on one or more objects detected in the first ROI and/or one or more objects detected in the second ROI to cause the vehicle to perform an autonomous driving operation. It will be appreciated that the aforementioned aspects are merely provided as examples and the various aspects claimed are not limited to the specific references and/or illustrations cited as examples.

One or more of the components, processes, features, and/or functions illustrated in FIGS. 1-8 may be rearranged and/or combined into a single component, process, feature or function or incorporated in several components, processes, or functions. Additional elements, components, processes, and/or functions may also be added without departing from the disclosure. It should also be noted that FIGS. 1-8 and its corresponding description in the present disclosure is not limited to dies and/or ICs. In some implementations, FIGS. 1-8 and its corresponding description may be used to manufacture, create, provide, and/or produce integrated devices.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples and is not intended to be limiting of examples of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, actions, operations, elements, and/or components, but do not preclude the presence or addition of one or more other features, integers, actions, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, and circuits described in connection with the aspects disclosed herein may be implemented or performed with a general purpose processor, a DSP, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations). Additionally, these sequence of actions described herein can be considered to be incorporated entirely within any form of computer-readable storage medium having stored therein a corresponding set of computer instructions that upon execution would cause an associated processor to perform the functionality described herein. Thus, the various aspects of the disclosure may be incorporated in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, action, feature, benefit, advantage, or equivalent to the public, regardless of whether the component, action, feature, benefit, advantage, or the equivalent is recited in the claims.

Further, those of skill in the art will appreciate that the various illustrative logical blocks, modules, circuits, and algorithm actions described in connection with the examples disclosed herein may be implemented as electronic hardware, computer software, or combinations of both. To clearly illustrate this interchangeability of hardware and software, various illustrative components, blocks, modules, circuits, and actions have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be incorporated directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art including non-transitory types of memory or storage mediums. An exemplary storage medium is coupled to the processor such that the processor can read information from, and write information to, the storage medium. In the alternative, the storage medium may be integral to the processor.

Although some aspects have been described in connection with a device, it goes without saying that these aspects also constitute a description of the corresponding method, and so a block or a component of a device should also be understood as a corresponding method action or as a feature of a method action. Analogously thereto, aspects described in connection with or as a method action also constitute a description of a corresponding block or detail or feature of a corresponding device. Some or all of the method actions can be performed by a hardware apparatus (or using a hardware apparatus), such as, for example, a microprocessor, a programmable computer or an electronic circuit. In some examples, some or a plurality of the most important method actions can be performed by such an apparatus.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that—although a dependent claim can refer in the claims to a specific combination with one or a plurality of claims—other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

Furthermore, in some examples, an individual action can be subdivided into a plurality of sub-actions or contain a plurality of sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

1. An apparatus, comprising:
a camera sensor of a vehicle; and
at least one processor communicatively coupled to the camera sensor, the at least one processor configured to:
receive an image from the camera sensor;
determine a first region of interest (ROI) within the image;
generate a first image of the first ROI, wherein a resolution of the first image is less than a resolution of the image;
detect one or more first objects in the first image;
determine a second ROI within the image based on an expected future position of the vehicle;
generate a second image of the second ROI; and
detect one or more second objects in the second image of the second ROI, wherein the one or more second objects are different than one or more first objects.

2. The apparatus of claim 1, wherein the first ROI corresponds to an entirety of the image.

3. (canceled)

4. The apparatus of claim 1, wherein the one or more first objects detected in the first image are larger than a threshold.

5. The apparatus of claim 1, wherein the second ROI corresponds to an area of the image associated with the expected future position of the vehicle.

6. The apparatus of claim 5, wherein the at least one processor is further configured to:
upscale a resolution of the second image to be greater than a resolution of the second ROI of the image.

7. The apparatus of claim 5, wherein the one or more second objects are smaller than a threshold and are associated with the expected future position of the vehicle.

8. The apparatus of claim 5, wherein the at least one processor is further configured to:
determine a location of the expected future position of the vehicle based on a speed of the vehicle, a steering direction of the vehicle, vehicle detections in the image or one or more previous images, lane boundary detections in the image or one or more previous images, or any combination thereof.

9. The apparatus of claim 8, wherein the speed of the vehicle indicates whether the vehicle is traveling straight, around a curve, rising in elevation, or descending in elevation.

10. The apparatus of claim 8, wherein the steering direction of the vehicle indicates whether the vehicle is traveling straight or curved.

11. The apparatus of claim 8, wherein vehicle detections having a size in the image smaller than a threshold indicate the expected future position of the vehicle.

12. The apparatus of claim 8, wherein a projection of the lane boundary detections in a bird's eye view indicates the expected future position of the vehicle.

13. The apparatus of claim 1, wherein the at least one processor is further configured to:
generate a control signal based on the one or more first objects detected in the first image and/or the one or more second objects detected in the second image to cause the vehicle to perform an autonomous driving operation.

14. The apparatus of claim 1, wherein the at least one processor is further configured to implement one or more neural networks to process the first image and the second image.

15. A method, comprising:
receiving an image from a camera sensor of a vehicle;
determining a first region of interest (ROI) within the image;
generating a first image from of the first ROI, wherein a resolution of the first image is less than a resolution of the image;
detecting one or more first objects in the first image;
determining a second ROI within the image;
generating a second image from of the second ROI based on an expected future position of the vehicle; and
detecting one or more second objects in the second image of the second ROI, wherein the one or more second objects are different than one or more first objects.

16. The method of claim 15, wherein the first ROI corresponds to an entirety of the image.

17. (canceled)

18. The method of claim 15, wherein the one or more first objects detected in the first image are larger than a threshold.

19. The method of claim 15, wherein the second ROI corresponds to an area of the image associated with the expected future position of the vehicle.

20. The method of claim 19, further comprising:
upscaling a resolution of the second image to be greater than a resolution of the second ROI of the image.

21. The method of claim 19, one or more second objects are smaller than a threshold and are associated with the expected future position of the vehicle.

22. The method of claim 19, further comprising:
determining a location of the expected future position of the vehicle based on a speed of the vehicle a steering direction of the vehicle, vehicle detections in the image or one or more previous images, lane boundary detections in the image or one or more previous images, or any combination thereof.

23. The method of claim 22, wherein the speed of the vehicle indicates whether the vehicle is traveling straight, around a curve, rising in elevation, or descending in elevation.

24. The method of claim 22, wherein the steering direction of the vehicle indicates whether the vehicle is traveling straight or curved.

25. The method of claim 22, wherein vehicle detections having a size in the image smaller than a threshold indicate the expected future position of the vehicle.

26. The method of claim 22, wherein a projection of the lane boundary detections in a bird's eye view indicates the expected future position of the vehicle.

27. The method of claim 15, further comprising:
generating a control signal based on the one or more first objects detected in the first image and/or the one or more second objects detected in the second image to cause the vehicle to perform an autonomous driving operation.

28. The method of claim 15, wherein one or more neural networks are used to process the first image and the second image.

29. An apparatus, comprising:
means for receiving an image from a camera sensor of a vehicle;
means for determining a first region of interest (ROI) within the image;
means for generating a first image of the first ROI, wherein a resolution of the first image is less than a resolution of the image;
means for detecting one or more first objects in the first image;
means for determining a second ROI within the image based on an expected future position of the vehicle;
means for generating a second image of the second ROI; and
means for detecting one or more second objects in the second image of the second ROI, wherein the one or more second objects are different than one or more first objects.

30. A non-transitory computer-readable medium storing computer-executable instructions, the computer-executable instructions comprising:
at least one instruction instructing a processor to receive an image from a camera sensor of a vehicle;
at least one instruction instructing the processor to determine a first region of interest (ROI) within the image;
at least one instruction instructing the processor to generate a first image of the first ROI, wherein a resolution of the first image is less than a resolution of the image;
at least one instruction instructing the processor to detect one or more first objects in the first image;
at least one instruction instructing the processor to determine a second ROI within the image based on an expected future position of the vehicle;
at least one instruction instructing the processor to generate a second image of the second ROI; and
at least one instruction instructing the processor to detect one or more second objects in the second image of the second ROI, wherein the one or more second objects are different than one or more first objects.
